(19) United States
(12) Patent Application Publication
(10) Pub. No.: US 2011/0297703 A1
(43) Pub. Date: Dec. 8, 2011

(54) MESS FREE DISPENSING NOZZLE AND CONTAINER WITH SUCK BACK FEATURE

(75) Inventors: Tracie WILSON, Westminster, MD (US); Jim WHISENHUNT, Independence, MO (US)

(73) Assignee: MCCORMICK & COMPANY, INCORPORATED, Sparks, MD (US)

(21) Appl. No.: 12/795,476

(22) Filed: Jun. 7, 2010

(51) Int. Cl. B05B 11/04; B65D 35/38; B65D 37/00

(52) U.S. Cl. 222/212; 222/420; 222/571

(57) ABSTRACT

A container especially adapted for dispensing food coloring includes a body including a neck with a nozzle including a skirt inserted into the body neck. The body neck and nozzle skirt together may have a plurality of beads to form an air and liquid (especially food coloring) tight seal. The nozzle includes a channel formed by substantially parallel walls including an orifice opening into the bottle at a first end of the channel, the orifice including a diameter of between 0.010 and 0.016 inches. The second end of the channel terminates in a flat nozzle tip for dispensing food coloring. The container provides an easy to use mess free dispenser with precise drop control and consistent drop size.

### BACKGROUND

Bottles containing liquid food coloring for use in decorating edible items such as eggs and icing have long been known in the art. It has also been known to use nozzles connected to the bottles for dispensing food coloring. However, the properties of commonly used liquid food coloring are such that it is particularly prone to leak and may be difficult to control. As a result the contents sometimes leak from known food coloring bottles during use and/or during storage after use. When food coloring leaks onto the surface of the bottle from the nozzle tip or remains on the nozzle tip after use, an undesirable mess may result for the user.

Many food coloring applications also require precise control of the quantity of food coloring liquid dispensed. For example, certain uses and recipes require a specific number of food coloring drops. Such precise control is difficult with some known food coloring dispensers.

Another problem with known food color nozzles is that once the required number of drops have been dispensed an additional drop may remain connected to the food color nozzle dispensing tip. If such drops separate from the tip in an uncontrolled fashion, food coloring may be applied to an undesired location such as a cooking work surface or a food item that was not intended to be colored. Even if the drop does not separate from the tip it may make a mess when a cap is placed on the nozzle tip at the conclusion of use and the food color drop is spread along the exterior surface of the nozzle and cap interior.

Another problem with known nozzles is that even when individual drops are dispensed, the drops sometimes have significantly different sizes. This is also undesirable where delivery of a precise quantity of food coloring is required.

Yet another feature of some known liquid dispensers is that the consumer cannot see the individual drops until just before or during dispensing because the drops are not visible prior to dispensing. As a result the consumer may not have sufficient warning that he or she is about to dispense a drop before doing so making it more difficult to apply a specifically required number of drops.

Finally, in some known food coloring bottles, food coloring may leak from the bottle over time under static conditions when the bottle is not in use even when the container has been properly filled and sealed. Such leaks are undesirable and may damage items surrounding the bottle.

Food coloring is typically applied from a dispenser when a user squeezes the dispenser body to force food coloring drops out of a dispenser nozzle. Leaks caused by drips from the nozzle can be avoided if the nozzle and bottle reliably operate to suck back unused liquid when a user releases the bottle after squeezing.

Bottles containing nozzles with suck back features have been known in other areas of technology. For example, bottles used to dispense eye drops and other pharmaceutical products that operate in a controlled fashion and suck back drops are known. However, when food coloring was placed into bottles designed for eye drops, the nozzles did not operate in an easy to control and mess free manner during use.

A known nozzle of this type is depicted in FIG. 1. In particular, when food coloring was used with a nozzle similar to FIG. 1, food coloring drops dispensed at the nozzle tip were inconsistent in size, drops remaining at the nozzle tip after the desired drops were dispensed could not be easily sucked back into the nozzle channel by the user at the conclusion of a use, the nozzle did not make an audible noise when drops were sucked back, and the user could not easily see drops as they were about to exit the nozzle channel.

Another known nozzle is shown in FIG. 2. The nozzle of FIG. 2 has been particularly used for food coloring.

Accordingly, it would be desirable to have a container and nozzle that can be used to dispense food coloring without food coloring remaining on the nozzle tip at the conclusion of use. It would also be desirable to have a food coloring nozzle and container that can easily suck back food coloring remaining in the nozzle after the desired amount is dispensed.

It would further be desirable to provide a nozzle that allows controlled dispensing of food coloring so that the user can dispense a specific number of drops as desired and that the drop size is generally consistent from drop to drop. It would be still further desirable to have the individual drops be visible to the consumer at the output of the nozzle and in a substantial portion of the nozzle channel before the drops are dispensed to facilitate user control.

Finally, it would be desirable to have a bottle that could be used to accomplish the above objectives not only with food coloring, but also with any liquid having properties (particularly including specific gravity, coefficient of friction, and viscosity) similar to food coloring.

### SUMMARY

In exemplary embodiments, a container for food coloring includes a body including a neck with a nozzle including a skirt inserted into the body neck. The body neck and nozzle skirt together may have a plurality of beads to form an air and liquid (especially food coloring) tight seal. The nozzle includes a channel formed by substantially parallel walls including an orifice opening into the bottle at a first end of the channel, the orifice including a diameter of between 0.010 and 0.016 inches. The second end of the channel terminates in a flat nozzle tip for dispensing food coloring.

During use, excess food coloring drops remaining at the nozzle tip can be sucked into the nozzle channel when a user releases pressure on the body of the bottle. Preferably, the user can easily control the number of drops dispensed from the container and can see the drops in the nozzle before they emerge from the nozzle tip. Also preferably, the drops will be of substantially uniform volume and the user will hear an audible sound when the drops are sucked back into the nozzle channel at the conclusion of a use.

### DESCRIPTION OF THE DRAWINGS

A more complete appreciation of the dispensing nozzle and container will be readily obtained as the same becomes better understood by reference to the following detailed description when considered in connection with the accompanying drawings, wherein:

FIG. 1 shows a cross section of a nozzle in a first known controlled drop tip bottle.

FIG. 2 shows a cross section of a nozzle in a nozzle used with a known food coloring bottle.

FIG. 3 is an exemplary embodiment of a cross sectional view of a body, nozzle, and cap.

FIG. 4 shows an exemplary embodiment of an exterior view of a dispensing body including finger grips.

FIG. 5 is an exemplary embodiment of a cross sectional view of a nozzle.

FIG. 5a of a nozzle portion containing an orifice.

FIG. 6 shows an exemplary embodiment of another cross sectional view of a body, nozzle, and cap.

FIG. 7 shows a cross sectional view of a further embodiment of a nozzle.

### DETAILED DESCRIPTION

Certain terminology is used in the following description for convenience only and is not limiting. The words “above,” “below,” “lower,” and “upper” designate directions in the drawings to which reference is made. The terminology includes the words noted above as well as derivatives thereof and words of similar import.

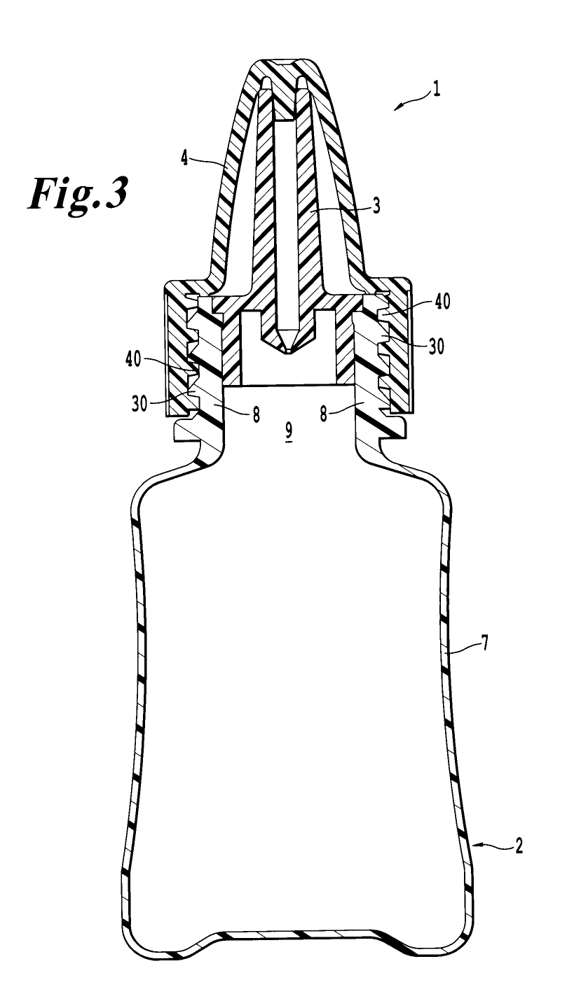

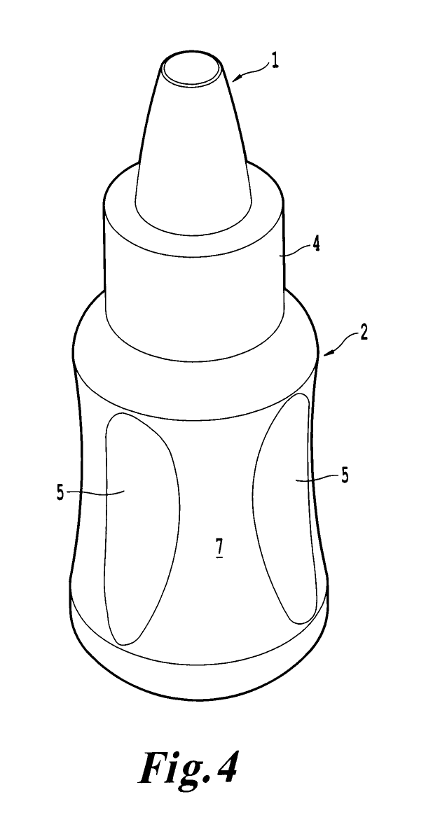

Food color containers, typically bottles, contain one or more colors for application to food. An exemplary dispenser is shown in FIG. 3. The dispenser 1 includes a body 2, a nozzle 3, and a cap 4. The body 2 may be of various shapes and may be generally cylindrical, hour-glass shaped, or have other shapes as desired for aesthetic and/or gripping purposes. Preferably, the body is hour glass shaped with finger indentations 5 as shown in FIG. 4 to facilitate gripping of the bottle.

The body and nozzle cooperate to provide a suck back feature to suck unused drops from the nozzle 3 back into the body 2 during use by a consumer. One factor affecting the effectiveness of the suck back feature is the selection of the body material. Thus, for example, the body may be made of low, medium, or high density polyethylene or blends of different densities. If the material density is too low, too much liquid tends to come out of the nozzle when the bottle is squeezed and user control during application of the product is reduced. If the material density is too high it may be too difficult for the user to apply sufficient pressure to the bottle to dispense the liquid. The body may thus be made of any suitable material such as polyethylene or polypropylene.

The neck 8 of the body 2 may optionally have threads 30 on the exterior that engage threads 40 on the interior of cap 4.

Another factor that affects the ability of the body and nozzle to cooperate and suck back drops is the thickness of the body material. If the material is too thick or too thin it may be difficult for the user to control dispensing of food coloring drops as desired.

Preferably, the bottle body is made of between 55 and 80% low density polyethylene and between 20 to 45% high density polyethylene. In one preferred embodiment the bottle body is made of a blend of about 70% low density polyethylene and about 30% high density polyethylene. The body walls generally have a thickness of between 0.011 and 0.020 inches.

Another aspect of the body that affects the ability to suck back drops after use is the uniformity in thickness of the body wall 7. If the thickness is not sufficiently uniform, then the amount of pressure required to dispense a drop may be unpredictable and the user will have less control in dispensing the food coloring. Preferably, the wall thickness will not vary more than ±0.004 inches.

The rheological properties of the food coloring liquid also interact with the bottle and nozzle and affect the desirable drip free, suck back, and drop control aspects of the dispenser 1. Relevant properties of the food coloring liquid include viscosity, coefficient of friction, specific gravity, and others. Preferably, the food coloring used with the bottle and nozzle can be obtained from McCormick® assorted food colors. While the invention is not limited to food coloring per se, the bottle and nozzle are designed to particularly work with food coloring and other liquids that have similar physical properties.

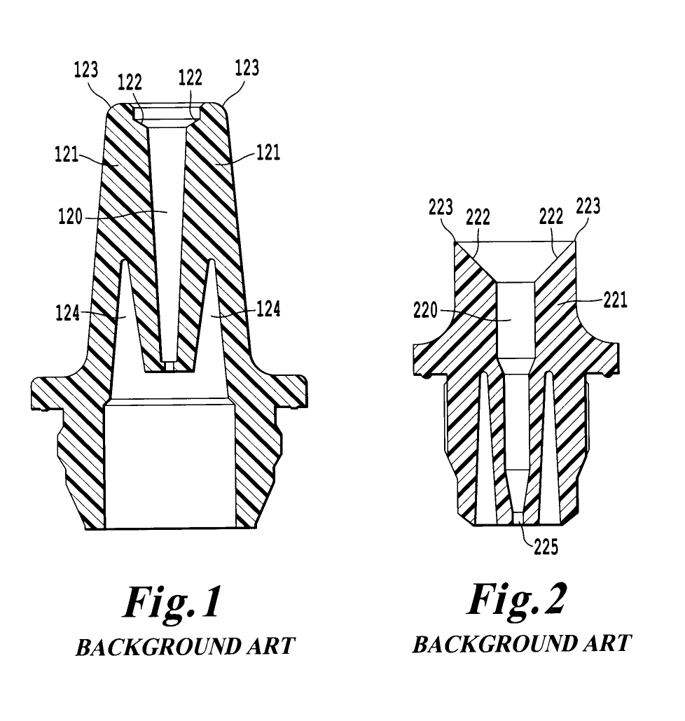

As shown in FIG. 1, some known nozzles for providing controlled application of liquids such as a eye drops have a conically shaped channel 120 defined by channel walls 121. In addition, in these known nozzles the channel includes an angled portion 122 where the channel widens and the nozzle tip 123 itself is rounded rather than flat. This nozzle also includes recessed portions 124 which tend to fill with food coloring during use and obscure the presence of food color drops in channel 20 during use. In addition, the drops are difficult to see as they move down much of the channel because the user has to look through two walls, or wall thicknesses, in the nozzle to see the drops in a substantial portion of the channel length.

As shown in FIG. 2, in a known nozzle used for food coloring, the channel 220 also widens at the tip 223 and includes an angled portion 222. In addition, in the nozzle of FIG. 2, the diameter of the orifice 225 is typically about 0.020 inches.

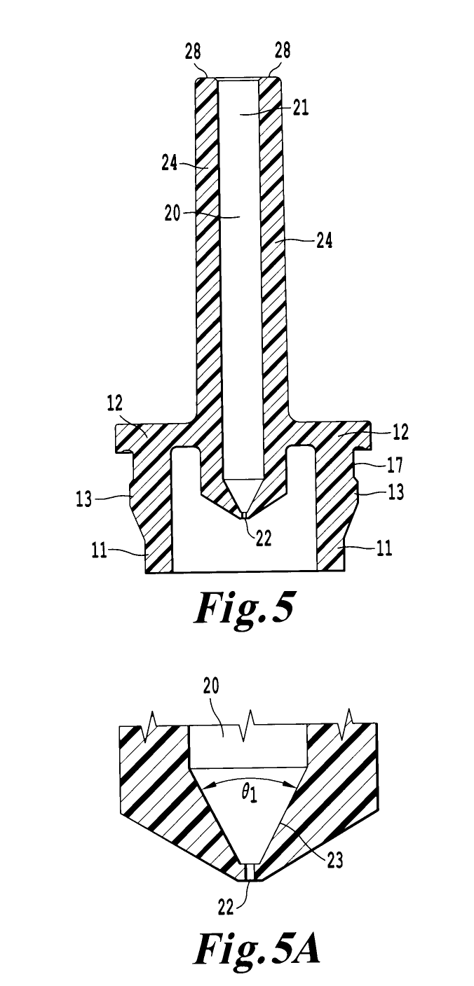

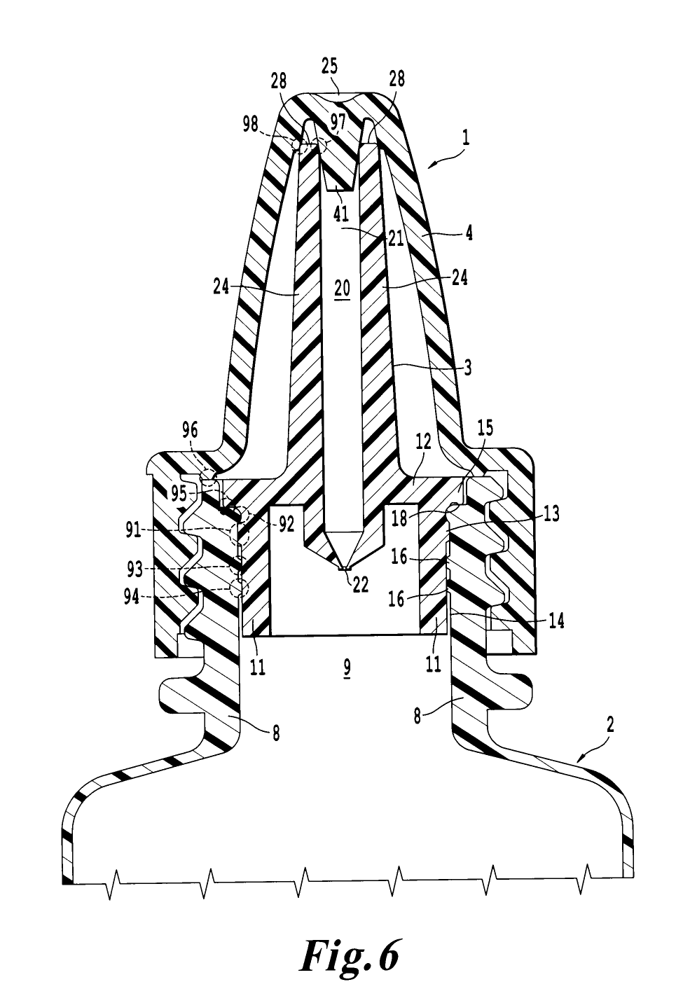

As shown in FIGS. 5 and 6, an exemplary embodiment of the nozzle 3 includes a circular skirt 11 that descends from a base 12. The circular skirt 11 is received by an opening 9 in the neck 8 of body 2. The skirt 11 may have one or more circumferential beads 13 that form a seal region 91 against an opposing surface of the neck 8. The bead 13 is designed to seal against the interior wall 14 of the neck 8. The interior wall 14 of the neck 8 may also have one or more circumferential beads 16 that extend to the outer wall 17 of skirt 11 to form additional seal regions 92, 93, 94. Preferably, multiple beads are formed in the outer wall 17 of skirt 11 and inner wall 14 of neck 8 to provide an air and liquid tight seal between the body 2 and the nozzle 3. These multiple beads are believed to create a tighter seal between the nozzle and bottle neck than the corresponding seal in known dispensers.

The base 12 of nozzle 3 may include a portion 15 that extends beyond the circular skirt 11. The portion 15 may also form an additional seal region 95 with the top 18 of the neck 8. The multiple seal regions 91-95 are believed to contribute to an improved suck back feature.

The nozzle 3 includes a channel 20 that includes a tip end 21 where the food coloring liquid is dispensed and an orifice 22 where the food coloring liquid enters the nozzle 3 from the body 2. Preferably, the diameter of the channel 20 at the nozzle tip 21 is about 0.060 inches, ±0.002 inches. The dimensions of the orifice 22 also play a role in the operation of the nozzle. Preferably, the diameter of the orifice 22 is between 0.006 and 0.019 inches. More preferably, the diameter of the orifice 22 is between about 0.008 and 0.018 inches, and still more preferably between 0.010 and 0.016 inches. Most preferably, the diameter of the orifice 22 is 0.013 inches±0.001 or 0.002 inches. If the diameter of the orifice 22 is too small, the part becomes difficult to manufacture. Preferably, the nozzle including the orifice is formed as a single molded part. However, it is also possible to form the nozzle without an orifice and then use a drill to form the orifice.

If the diameter of the orifice 22 becomes too large, it becomes more difficult for a user to control the amount of food coloring liquid dispensed. Also, as the orifice size increases, both the drop size and the variation in drop size tend to increase. Since most food recipes require a specific number of food color drops and assume a specific volume of liquid in each drop, variability in drop size is undesirable.

The exact dimensions of the orifice 22 may also depend on the specific food coloring. Different food coloring has different rheological properties. For example, it has been found that yellow food coloring may have different properties than other food colors.

As shown in FIG. 5A, channel 20 may have a cone shaped portion 23 at the orifice end of the channel. In a preferred embodiment the angle θ₁ of the cone shaped portion 23 is 50°. The walls 24 of the main portion of the channel 20 are typically substantially parallel to one another, although they may have a slight draft angle such as 1.0° from an axis 25 of the channel 20. As a result, the diameter of the channel 20 is substantially constant along its length. As used herein, references to channel diameter do not include the channel diameter of the portion of the channel along cone shaped portion 23. In a preferred embodiment, the diameter of the main body portion of the channel is about 0.060 inches±0.003 inches.

The channel length is also believed to have an impact on control of the food coloring drops. In one embodiment the channel length is about 0.67 inches from the end of the nozzle tip 21 through the nozzle base 12 (excluding the nozzle skirt below the base 12). Applicants have found this length advantageous in that it is sufficiently long to allow the user to see the drops in the channel before they are dispensed. In other embodiments, the channel length may range from 0.50 to 0.80 inches, such as 0.55 inches, or may be selected as desired.

Preferably, the nozzle tip 28 is flat across the top rather than rounded. In addition, the diameter of the channel at the tip 28 is substantially the same as the main channel diameter. A flat nozzle tip having substantially the same diameter as the main channel also helps control drop size and provides for greater control in dispensing drops and sucking back unused drops at the conclusion of a use.

The nozzle 3 may be made of the same or different material than the body 2. Preferably, the nozzle 3 may be made of a low density polyethylene. Nozzles made of low density polyethylene are particularly advantageous in preventing leaks. The inherent elasticity of low density polyethylene nozzles allows the nozzle to deform and help maintain a seal in a static condition. The seals will be maintained against the body neck and cap even if inadvertent pressure is applied to the container, such as when an object inadvertently falls on the container or a child squeezes the container with the cap on.

The cap 4 may include projection 41 that is inserted into the dispensing end of the nozzle tip 21 of the nozzle 3 to create a seal. Preferably, engagement of the cap 4 with the nozzle tip 21 creates first and second seal regions 97, 98 to ensure that the food coloring does not leak out of the container during storage. A further seal region 96 may be formed between the cap and the end of the body neck 8. Having both inner seal 97 and outer seal 98 between the nozzle tip 21 and cap 4 helps prevent leaks. Preferably, the cap is made of polypropylene.

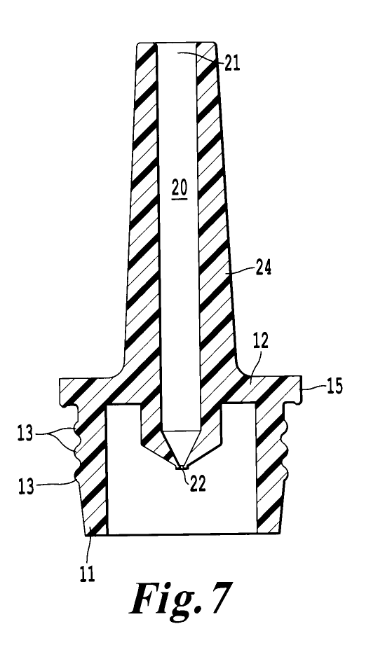

An alternative nozzle design is shown in FIG. 7. In this embodiment the nozzle skirt 11 includes three circumferential beads 13 which seal against an opposing flat interior bottle neck surface (not shown).

The beads 13 and 16 shown in FIGS. 6 and 7 may be rounded or may have a shape selected as desired.

During use, a consumer removes the cap from the nozzle and then squeezes the body to control the amount of food coloring dispensed by the dispenser. Preferably, the consumer controls the amount of food coloring to dispense a specific number of drops required. When the consumer is finished dispensing, drops will likely remain in the nozzle 3 or attached to the nozzle tip that could potentially leak if not returned to the body 2.

Accordingly, when the consumer releases the pressure placed on the bottle, the elastically deformed bottle will return to its normal size, creating a vacuum in the body 2. As there are multiple seals between the body 2 and the nozzle 3, the vacuum is only filled with air entering the body 2 through the channel 20. Therefore, airflow through the nozzle channel 20 created by the vacuum will pull drops remaining in or attached to the nozzle 3 back into the body 2. Due to the dimensions and configurations of the nozzle 3 discussed above, by partially deforming the bottle the user can also control the number of drops dispensed.

Preferably, the dispenser also makes an audible sound to the user when a drop is sucked back.

Exemplary nozzles according to the invention have produced substantially consistent drop sizes and also passed drop tests and pressurized leak tests. A bottle and nozzle prepared according to the invention and having at least three seal regions (or rings) between the nozzle and the bottle neck (see, e.g., FIGS. 6 and 7) did not fail until at least 140 lbs. of force had been applied to the bottle. When failure occurred food coloring leaked between the neck of the bottle and the skirt of the nozzle. Preferably, a nozzle and bottle will survive a leak test until at least 80 lbs of force has been applied, more preferably 100 lbs of force, still more preferably 120 lbs of force, and most preferably until at least about 140 lbs of force. In contrast, a known food coloring bottle failed after only 35-40 lbs. of force was applied to the bottle.

In each of the summary of examples reported below, the nozzle tip was flat. The specific food color used is indicated in parentheses next to each example. In Examples 1-4 the attributes reported are averages for 10 sample nozzles. In Examples 5-8, the attributes reported are for 5 sample nozzles. In the examples the nozzle height (as measured from the nozzle tip to the bottom of the nozzle base and excluding the nozzle skirt) averaged between 0.58-0.60 inches, the outer diameter of the tip averaged 0.13 inches, the outer diameter of the nozzle skirt averaged 0.34 inches, the outer diameter of the one nozzle seal bead averaged 0.35 inches, the inner diameter of the nozzle tip averaged 0.058 inches, and the nozzle weight averaged 0.34 g. In these examples, a quarter ounce bottle with used, the nozzle was made of low density polyethylene, and the bottle was made of a blend of 70% low density polyethylene and 30% high density polyethylene.

### EXAMPLE 1 (Green)

Orifice diameter: 0.016 in.

Drop Size Average: 0.024 g

Drop Size Variation: 0.001 g

### EXAMPLE 2 (Red)

Orifice diameter: 0.016 in.

Drop Size Average: 0.024 g

Drop Size Variation: 0.001 g

### EXAMPLE 3 (Yellow)

Orifice diameter: 0.016 in.

Drop Size Average: 0.023 g

Drop Size Variation: 0.001 g

### EXAMPLE 4 (Blue)

Orifice diameter: 0.016 in.

Drop Size Average: 0.024 g

Drop Size Variation: 0.001 g

### EXAMPLE 5 (Yellow)

Orifice diameter: 0.017 in.

Drop Size Average: 0.025 g

Drop Size Variation: 0.006 g

### EXAMPLE 6 (Red)

Orifice diameter: 0.014 in.

Drop Size Average: 0.027 g

Drop Size Variation: 0.002 g

### EXAMPLE 7 (Green)

Orifice diameter: 0.014 in.

Drop Size Average: 0.027 g

Drop Size Variation: 0.002 g

### EXAMPLE 8 (Blue)

Orifice diameter: 0.015 in.

Drop Size Average: 0.027 g

Drop Size Variation: 0.001 g

As can be seen from the examples, all of the exemplary nozzles consistently produced similar average drop sizes ranging from 0.023 to 0.027 g, and with the exception of the 0.017 inch orifice with yellow food coloring of Example 5, very little variation in drop size occurred. The 0.006 g variation in drop size with the relatively larger 0.017 inch orifice of Example 5 thus shows how the drop size variation increases with orifice size, particularly with an orifice size greater than 0.016 inches. Preferably, the drop size variation averages less than 0.005 g, and more preferably is 0.002 g or less, as measured over 5 to 10 drops. All of the above examples also passed drop tests and pressurized leak tests.

Thus, the foregoing discussion discloses and describes merely exemplary embodiments. As will be understood by those skilled in the art, the nozzle may be embodied in other specific forms without departing from the spirit or essential characteristics thereof. Accordingly, the present disclosure is intended to be illustrative, but not limiting in scope. The disclosure, including any readily discernible variants of the teachings herein, define, in part, the scope of the foregoing claim terminology such that no inventive subject matter is dedicated to the public.

What is claimed is:

1. A nozzle, comprising:
a wall defining a substantially cylindrical channel including first and second ends, said channel having a substantially constant diameter,
said first end of the channel including an orifice of 0.008 to 0.019 inches in diameter,
said second end of the channel forming a dispensing tip defined by an end of said channel wall which is substantially flat;
a cylindrical skirt portion; and
means for forming at least three seal regions with a bottle.

2. A dispensing container for food coloring, comprising:
a body containing food coloring including a neck;
a nozzle including a cylindrical skirt for engaging said neck; and
a removable cap for insertion into said nozzle, wherein the body and the nozzle comprise:
means for dispensing substantially constant volume drops of food coloring,
means for sucking back non-dispensed drops from a tip end of the means for dispensing into the body, and
wherein the nozzle skirt and body neck form at least two seals to form an air and liquid tight seal between the body neck and the nozzle skirt.

3. A dispensing container, comprising:
a body, said body including a neck;
a nozzle including a cylindrical skirt for engaging said neck; and
a removable cap for insertion into said nozzle,
said nozzle including a wall defining a substantially cylindrical channel including first and second ends, said channel including a substantially constant diameter,
said second end of the channel forming a dispensing tip defined by an end of said channel wall, the dispensing tip being substantially flat,
said nozzle skirt and body neck collectively including at least two beads to create an air and liquid tight seal between the neck and the nozzle skirt.

4. A dispensing container according to claim 3, wherein said body contains food coloring.

5. A dispensing container according to claim 3, wherein said body and said nozzle together comprise means for dispensing food coloring drops having a drop size variation of 0.002 g or less as measured over 5 to 10 drops.

6. A dispensing container according to claim 3, wherein said channel has a diameter of 0.060±0.002 inches.

7. A dispensing container according to claim 3, wherein the container makes an audible sound when liquid drops are sucked back into the nozzle through the dispensing tip.

8. A dispensing container according to claim 3, wherein the container dispenses liquid drops of substantially constant volume and an average drop size of 0.023-0.035 g.

9. A dispensing container according to claim 3, wherein the nozzle skirt and body neck form at least three seals to form an air tight seal between the body neck and the nozzle skirt.

10. A dispensing container according to claim 3, wherein the nozzle skirt and body neck collectively include at least 2 beads.

11. A dispensing container according to claim 3, wherein the body comprises between 55 and 80% low density polyethylene and between 20 and 45% high density polyethylene.

12. A dispensing container according to claim 11, wherein the body comprises about 70% low density polyethylene and about 30% high density polyethylene.

13. A dispensing container according to claim 11, wherein said nozzle comprises low density polyethylene.

14. A dispending container according to claim 3, further comprising a removable cap, wherein the cap and the dispensing tip form both an inner seal and outer seal at a dispensing tip-cap interface.
